(19) United States
(12) Patent Application Publication
(10) Pub. No.: US 2026/0073398 A1
(43) Pub. Date: Mar. 12, 2026

(54) CREDIT CARD PROCESSING USING UNIVERSAL CHARGEBACK DATABASE

(71) Applicant: MASTERCARD INTERNATIONAL INCORPORATED, Purchase, NY (US)

(72) Inventors: Selwyn Kaitha, Mumbai (IN); Rohan Ganpat Rane, Jagdusha Nagar (IN); Shweta Vichare, Mumbai (IN)

(21) Appl. No.: 19/260,739

(22) Filed: Jul. 7, 2025

Related U.S. Application Data
(60) Provisional application No. 63/668,726, filed on Jul. 8, 2024.

(51) Int. Cl. G06Q 20/40; G06Q 20/34

(52) U.S. Cl. CPC G06Q 20/407; G06Q 20/354

(57) ABSTRACT

A method and system are provided for issuing new financial cards to customers and for determining whether to approve chargeback requests made by customers. The method and system utilize a chargeback database that is accessible by multiple card issuers. The chargeback database uses customer identifiers that are unique for each customer in the database. Card issuers are able to search the database to retrieve historical chargeback data involving a particular customer. The historical chargeback data includes chargeback requests made to any card issuer with access to the database.

### CROSS REFERENCE TO RELATED APPLICATIONS

This application claims the benefit of U.S. provisional application number 63/668,726 filed on Jul. 8, 2024, which is incorporated by reference herein.

### BACKGROUND

The present inventions relate generally to financial transaction processing, and more particularly, to processes for minimizing fraudulent chargeback requests.

Modern consumer payment systems commonly utilize sophisticated transaction systems involving one financial institution associated with the consumer (issuer), another financial institution associated with the merchant (acquirer) and a card network (e.g., Mastercard, Visa, Discover, American Express) that facilitates payments from the issuer to the acquirer. One problem that such payment systems suffer from is fraud which results in significant unwarranted costs that are absorbed in various ways by each of the entities participating in the system.

One type of fraud that is not currently well understood by the industry is chargeback fraud committed by customers. Chargebacks themselves are relatively common in such payment systems and conventional systems exist for processing chargebacks. That is, when a customer receives his or her regular statement from the card issuer (i.e., with a list of financial transactions that have been attributed to the customer), the customer may identify transactions that the customer did not authorize. The customer may then approach the card issuer indicating that a particular financial transaction should not have been attributed to the customer (because it was allegedly not authorized) and may make a chargeback request to the card issuer. The card issuer will then investigate the claim and in most cases the card issuer approves the chargeback request and releases the customer from the obligation to pay for the financial transaction.

However, in these incidents, the underlying financial transaction at issue typically involves a merchant who actually provided goods or services to someone (e.g., a fraudster other than the customer). Thus, in these cases, the payment system suffers actual monetary losses that are typically uncovered and must be borne by the various entities that support the system (but not the customer since the transaction was allegedly unauthorized).

In some cases, however, chargeback requests by a customer may be fraudulently claimed by the customer themself. That is, even though the customer may have actually authorized a financial transaction, it is possible that a customer may fraudulently claim that a financial transaction was unauthorized in order to make an illegitimate chargeback request so that the customer can avoid paying for the financial transaction. Although it is understood that some amount of chargeback requests may involve customer fraud as opposed to sophisticated third-party fraud, customer-initiated chargeback fraud has not been well documented and the total amount of chargeback fraud that is caused by customers themselves is not known. However, it is possible that this type of fraud is substantial and imposes costs on the system that are not borne by the perpetrators of such fraud.

Improved systems for documenting such possible fraud would be desirable in the field of credit card processing.

### SUMMARY

A method and system are described for storing chargeback data for individual customers in a way that is accessible to many different card issuers. Card issuers may search a chargeback database for historical chargeback data linked to a particular customer even if previous chargeback requests were made to a different card issuer.

This allows card issuers to make determinations of whether to issue a new card to a customer and whether to approve chargeback requests made by customers. The invention may also include any other aspect described below in the written description or in the attached drawings and any combinations thereof.

### BRIEF DESCRIPTION OF SEVERAL VIEWS OF THE DRAWINGS

The invention may be more fully understood by reading the following description in conjunction with the drawing, in which:

FIG. 1 illustrates a schematic of a payment system showing card issuers, card networks and acquirers;

FIG. 2 illustrates a schematic of a payment system showing a card issuer, card network, acquirer, customer and merchant;

FIG. 3 illustrates a schematic of chargeback database being accessed by multiple card issuers;

FIG. 4 illustrates a flow chart showing the chargeback database being used to approve or deny a new card to a customer and to approve or deny a chargeback request; and

FIG. 5 illustrates a block diagram showing an example embodiment of the credit card processing system.

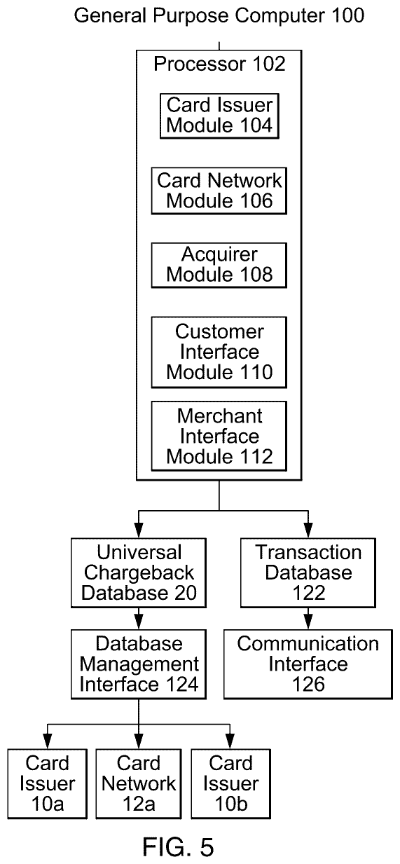

### DETAILED DESCRIPTION

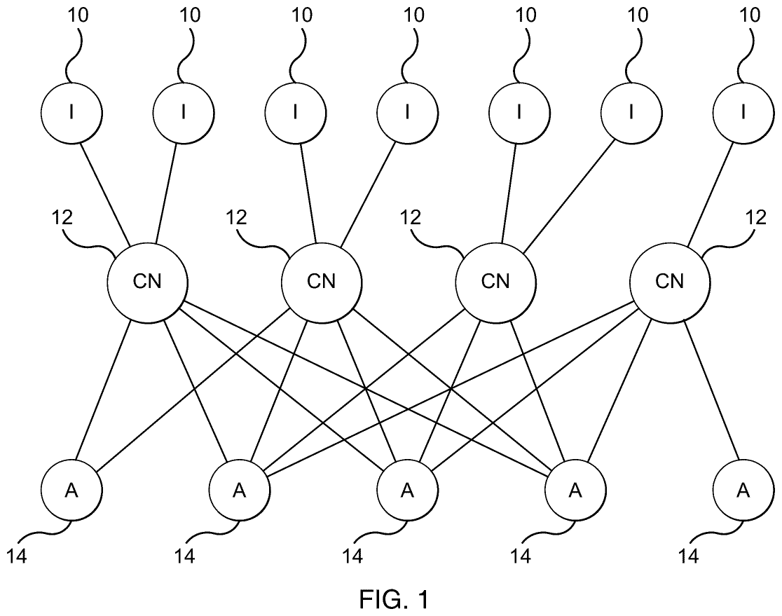

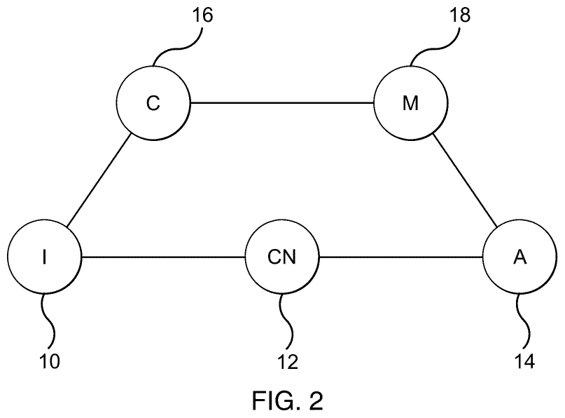

Referring now to the figures, and particularly FIG. 1, a schematic of a credit card processing system is shown. As shown, the system typically involves three entities—card issuers 10, card networks 12 and acquirers 14 (in addition to customers 16 and merchants 18, see FIG. 2). The card networks 12 are companies, such as MasterCard, Visa, Discover and American Express, that process financial transactions between the card issuers 10 and the acquirers 14. Typically, the card issuer 10 is associated with one of the card networks 12, and each of the card networks 12 are associated with multiple card issuers 10 who issue cards to customers 16 that are associated with the particular card network 12. However, it is understood that some card issuers 10 may issue cards to its customers 16 from more than one of the card networks 12. Each of the acquirers 14 typically accept financial transactions processed through multiple card networks 12. However, it is possible for an acquirer 14 to choose to only process transactions from particular card networks 12 if desired. Although FIG. 1 illustrates a limited number of card issuers 10 and acquirers 14, it is understood that the number of card issuers 10 and acquirers 14 in such a system typically measure in the thousands. By contrast, there are a relatively few number of card networks 12.

Turning to FIG. 2, a simpler schematic is shown which also includes customers 16 and merchants 18. It is understood that a completed diagram like this would be impossible to show because the number of cardholders 16 (i.e., customers 16) and merchants 18 can number in the millions. Even so, it can be seen that in a typical credit card processing system that the customer 16 primarily interacts with the card issuer 10 and a merchant 18. That is, the cardholder 16 keeps a credit card account with the card issuer 10 and retains a credit card that was issued by the card issuer 10 which the customer 16 uses to authorize various financial transactions. The underlying financial transactions are initiated by the customer 16 by purchasing goods or services from a merchant 18 and authorizing payment for the goods or services using the credit card issued by the card issuer 10. The card issuer 10 later issues a statement to the customer 16 and receives payment from the customer 16 to cover the financial transactions authorized by the customer 16.

The merchant 18 principally interacts with an acquirer 18, in addition to interacting with the customer 16 to sell the goods or services. Once the purchase is complete, the merchant 18 provides the purchase details to the acquirer 14, including at least the financial amount of the transaction and the credit card number used by the customer 16 to authorize the purchase. The acquirer 18 then submits the financial transaction to the card network 12 associated with the credit card used by the customer 16. The card network 12 then processes the financial transaction and facilitates the transfer of financial funds from the card issuer 10 to the acquirer 14 to satisfy the financial transaction. It is understood that in such a system with millions of customers 16 and merchants 18 and thousands of card issuers 10 and acquirers 14 that the system must be able to process millions of financial transactions on a constant basis and that such credit card processing can only be accomplished using automated computer systems usually involving computer servers employing multiple computer processors and computer memory storing the computer instructions which cause the processors to automatically process millions of financial transactions.

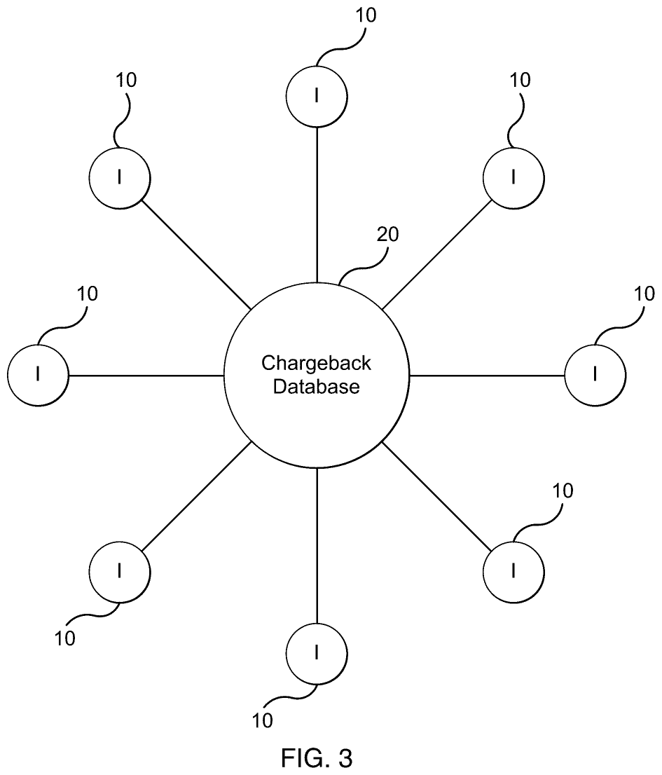

Turning to FIG. 3, the payment system may be provided with a universal chargeback database 20. Although the chargeback database 20 may be maintained by various entities, one of the card networks 12 preferably owns and maintains the chargeback database 20. That is, the database manager provides the computer server (e.g. computer memory and processors) that allow the database to function. The database manager also preferably provides the user interfaces needed to access and modify data in the database 20 as well as conventional database maintenance requirements. Although one of the card networks 12 may be responsible for maintaining the chargeback database 20, the database 20 is preferably accessible to other entities as well for both searching the database 20 for information related to chargebacks and for entering new data into the database 20 related to chargebacks.

For example, as shown in FIG. 3, it may be desirable for the chargeback database 20 to be accessible by many different card issuers 10. Further, it may be desirable to permit access to the chargeback database 20 by all card issuers 10, including card issuers 10 associated with any card network 12. Thus, although the chargeback database 20 may be managed by one of the card networks 12, in the preferred embodiment any of the card networks 12 and card issuers 10 may be able to utilize the chargeback database 20.

The chargeback database 20 preferably includes customer identifiers that uniquely identify each customer 16 in the database 20. That is, the unique customer identifiers are preferably not credit card numbers or other types of identifiers that could change over time. Instead, the customer identifiers are preferably permanent identifiers that do not change over time and sufficiently identify a particular individual 16 distinctly from all other individuals 16 in the database 20. In one embodiment, the customer identifiers are preferably based on one or more government issued identifiers. For instance, in the United States, individuals are issued social security numbers which uniquely identify individual people from each other. In another example, citizens of India are issued unique AADHAAR and PAN numbers. Other countries issue similar types of governmentally issued unique identifiers. Thus, in one embodiment, the customer identifiers in the chargeback database 20 may be governmentally issued identifiers like U.S. social security numbers, Indian AADHAAR and PAN numbers, and/or other similar types of government issued identifiers. However, in another embodiment, the customer identifiers are not the actual government identifiers, but instead, are coded identifiers that are converted from government issued identifiers. For instance, the customer identifiers may be encrypted values instead of the actual government issued identifiers which have been encrypted using the government issued identifier as a basis for the encryption. That is, the database 20 preferably includes a table or other converter that converts government issued identifiers into unique encrypted values that can be later searched using the individual's unique government issued identifier.

The chargeback database 20 also preferably includes historical chargeback data for each individual 16 in the database 20. That is, each time that a customer 16 makes a request for a chargeback, the card issuer 10 who received the chargeback request may enter the chargeback request into the database 20 by linking the chargeback request to the unique customer identifier since the chargeback database 20 may be accessible by many different card issuers 10. The historical chargeback data linked to a particular individual 16 may record all of the chargeback requests that a customer 16 has ever made even with cards that were issued to the customer 16 by different card issuers 10. In the preferred embodiment, card issuers 10 will have access to a customer's entire historical chargeback data even for chargeback requests made to different card issuers 10 and chargeback requests made with cards associated with different card networks 12. Likewise, since the customer identifier is a unique identifier that does not change due to card changes and the like, the historical chargeback data for an individual 16 can continue to be updated over long periods of time even as a particular individual 16 changes addresses, account numbers, etc.

Although the database 20 could include every customer 16 that various card issuers 10 have issued cards to, in the preferred embodiment it is envisioned that only customers 16 who have previously made a chargeback request will be included in the chargeback database 20. In other words, in the preferred embodiment, any particular individual 16 will not initially be entered into the database 20. Instead, when a card issuer 10 receives a chargeback request from a customer 16, the card issuer 10 may search the database 20 for the customer 16 in order to add the chargeback request to the particular customer's historical chargeback data. However, if this is the first chargeback request ever made by the customer 16, the card issuer 10 may not find the customer 16 in the database 20 when the card issuer 10 searches for the particular customer 16. In that case, the card issuer 10 may add the customer 16 to the database 20 with details of the chargeback request made by the customer 16.

Thereafter, if the customer 16 later makes another chargeback request, either to the same card issuer 10 or to a different card issuer 10. The customer 16 will already have been entered into the database 20 and the later chargeback request can be added to the customer's historical chargeback data along with all previous chargeback requests made by the customer 16. Typically, the historical chargeback data will include a variety of details to allow card issuers 10 to analyze the chargeback data in various ways. For example, the chargeback data may include the amount of the chargeback request, the date of the chargeback request, the merchant 18 involved in the chargeback request, the card number involved in the chargeback request, etc.

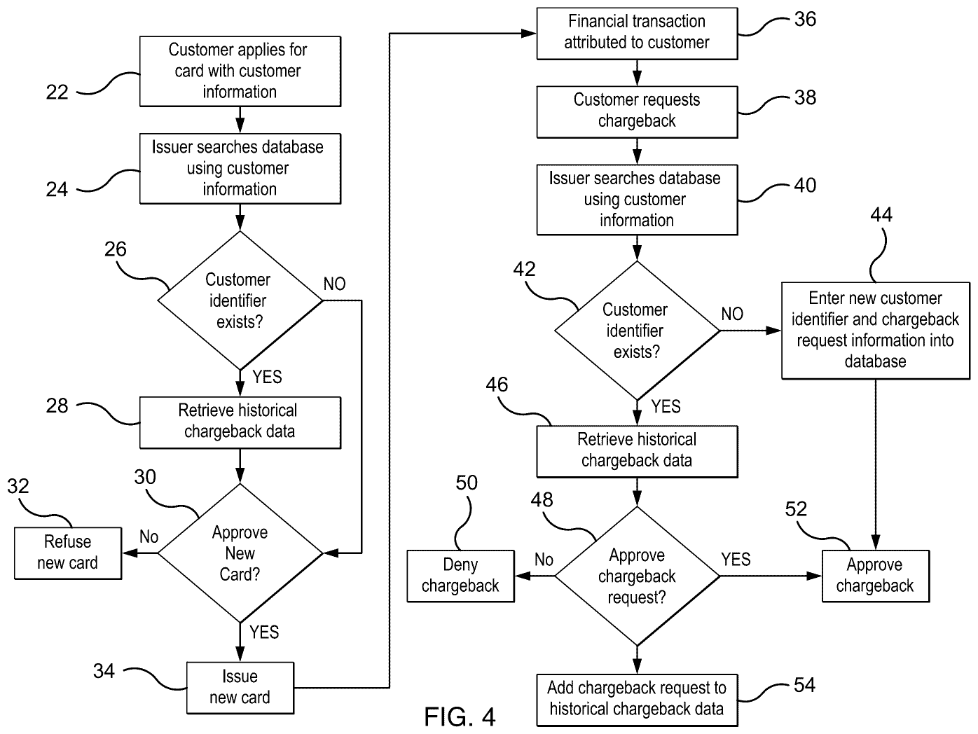

Turning to FIG. 4, a flowchart illustrating how the chargeback database 20 may be used is shown. In one embodiment, the chargeback database 20 may be used by issuers 10 when determining whether to issue a new credit card to a customer 16. In such a process, the customer 16 typically fills out an application and submits it to an issuer 10 in order to request a new card. In the described process, the customer 16 provides the issuer 10 with sufficient information about the customer 16 in order for the issuer 10 to uniquely identify the customer 16 (22). For example, the customer information provided to the card issuer 10 may include a government issued identifier like a U.S. social security number, an Indian AADHAAR and PAN numbers, or other similar government issued identifier. The card issuer 10 then accesses and searches the chargeback database 20 using the provided customer information (24). Where the database 20 does not actually store government identifiers themselves (e.g. where encrypted values are stored), the database 20 may provide a converter for converting the customer information (e.g. government issued identifier) to a customer identifier that corresponds to the customer identifiers stored in the database 20.

In searching the database, the card issuer 10 initially determines whether a customer identifier matching the customer information exists in the database 20 (26). If there is no matching customer identifier in the chargeback database 20, this will typically mean that the customer 16 has not previously made a chargeback request to any card issuer 10 with access to the database 20. Thus, in this instance, the process skips to the final determination of whether to issue a new card to the customer 16 (30). On the other hand, if a matching customer identifier exists in the chargeback database 20, this will typically mean that the customer 16 has previously made one or more chargeback requests to one or more card issuers 10 with access to the database 20. In this case, the card issuer 10 retrieves the historical chargeback data stored in the database 20 which is linked to the particular customer identifier (28). The card issuer 10 then makes a determination of whether to issue a new card to the customer 16 (30).

In most instances, a card issuer 10 will utilize a variety of factors with a weighting algorithm to make the final determination of whether to issue a new card to the customer 16. For example, one conventional factor commonly used by card issuers 10 is the CIBIL score which uses an individual's credit history to assess the risk associated with a particular individual 16. However, by using the chargeback database 20, card issuers 10 may also evaluate the risk that a customer 16 requesting a new card will request chargebacks in the future after a new card has been issued. That is, if the historical chargeback data linked to the particular customer 16 in the database 20 shows that the customer 16 has previously requested many chargebacks with cards issued by multiple different card issuers 10, the card issuer 10 is likely to assess that there is a high risk that the customer 16 will request future chargebacks if the card issuer 10 issues a new card to the customer 16. Thus, in this case, the card issuer 10 will likely reject the customer's application for a new card and refuse to issue a new card (32). Various types of thresholds may be used for this determination. On the other hand, if the customer 16 is not in the database 20 (i.e., has no chargeback history) or if the chargeback history for the customer 16 is normal compared to averages, the card issuer 10 may approve the customer's application and issue a new card to the customer 16 (34).

The chargeback database 20 may also be used by card issuers 10 to determine whether to approve a chargeback request. Thus, in FIG. 4, the process may continue after a new card is issued to a customer 16. Thereafter, the card issuer 10 attributes various financial transactions to the customer 16 (36). However, in response to a statement issued to the customer 16 detailing all of the financial transactions attributed to the customer 16, the customer 16 may believe that one or more of the transactions were unauthorized and may make a request to the card issuer 10 for a chargeback of the transaction at issue (38). The card issuer 10 may then search the chargeback database 20 using the customer's customer information as previously described (40).

In searching the database 20, the card issuer 10 initially determines whether a customer identifier matching the customer information exists in the database (42). If there is no matching customer identifier in the chargeback database 20, this will typically mean that the customer 16 has not previously made a chargeback request to any card issuer 10 with access to the database 20 (i.e., that the current chargeback request is the first one that the customer 16 has made). In response, the card issuer 10 may enter the customer information into the database 20 (which may be the same as the customer identifier or may be converted by the database 20 into a customer identifier). Additionally, the card issuer 10 may enter details (e.g., financial amount, date, merchant 18, card number, etc.) about the current chargeback request into the database 20 with a link to the customer identifier (44).

When there is no historical chargeback data for a particular customer 16, the card issuer 10 will typically authorize the chargeback request (52), but it is possible for the card issuer 10 to use other information to deny the request in some situations. On the other hand, if a customer identifier exists in the database 20 for the particular customer 16, the card issuer 10 then retrieves the historical chargeback data linked to the customer 16 (46). The card issuer 10 then makes a determination of whether to approve or deny the chargeback request (48). It is likely that the card issuer 10 will include other factors into the determination in addition to the customer's chargeback history retrieved from the database 20. However, if the customer's historical chargeback data shows that the customer 16 has made many chargeback requests, especially when the chargeback requests have been made to multiple different card issuers 10 and different card numbers, the card issuer 10 may determine that there is a greater likelihood that the present chargeback request may be the result of customer 16 involved fraud. Thus, in this situation, the card issuer 10 may deny the customer's request for a chargeback (50). Various types of thresholds may be used for this determination. On the other hand, if the customer's historical chargeback data is normal compared to averages, the card issuer 10 may approve the chargeback request (52).

In either event, the card issuer 10 will typically add details of the chargeback request into the historical chargeback data for the customer 16 in the database 20 for future searches by any card issuer 10 who uses the database 20 (54). Thus, the system allows different card issuers 10 to search the chargeback database 20 for any customer 16 who has a history of requesting chargebacks regardless of what card issuer 10 or card network 12 was involved in the chargeback. As a result, it may be common for the chargeback request at issue to involve a financial transaction with one credit card issued by a particular card issuer 10 and associated with a particular card network 12, and yet the historical chargeback data used to make the determination of whether to approve or deny the request may involve chargeback requests made by the customer 16 to different card issuers 10 involving different credit cards associated with different card networks 12.

The system may include a general purpose computer 100 having a processor 102 configured with a plurality of modules for processing financial transactions. The processor 102 includes a card issuer module 104 for managing communications and operations with card issuers 10, a card network module 106 for processing card network transactions with card networks 12, and an acquirer module 108 for handling acquirer-related functions with acquirers 14. The system further includes a customer interface module 110 for managing interactions with customers 16 and a merchant interface module 112 for processing communications with merchants 18.

The general purpose computer 100 is operatively connected to the chargeback database 20 that serves as a centralized repository accessible by multiple card networks 12 and card issuers 10. Although the universal chargeback database 20 may be maintained by one of the card networks 12a, the database 20 is preferably accessible to other entities including card issuers 10a, 10b for both searching chargeback-related information and entering new chargeback data. The system includes a database management interface 124 that provides user interfaces and access control for the universal chargeback database 20, as well as a transaction database 122 for maintaining transaction records. Communication interfaces 126 facilitate connectivity with the various entities in the payment processing ecosystem.

It is understood that the described financial processing system is intended to operate autonomously on programmed computer systems utilizing computer algorithms such that the system may be implemented by one or more computer processors (e.g., in a server system) executing computer-executable instructions stored on a non-transitory computer-readable storage medium. Thus, for example, in the case of the chargeback database 20 and related steps described herein, it is unnecessary for human beings to make the required data transmissions, determinations, etc. Similarly, the card issuers 10 will typically utilize autonomous computer algorithms implemented by one or more computer processors executing computer-executable instructions stored on a non-transitory computer-readable storage medium to approve or deny new card applications or chargeback requests. This autonomous design makes the payment system scalable to a level that would be impractical if human beings were to attempt to perform the steps required by the system. While it is understood that various human beings may provide inputs to the system and may adjust parameters that control how the system operates, the payment processing system is intended to have the capability of processing many thousands of card applications, chargeback request reviews and other chargeback searches in short periods of time (e.g., seconds or less) that would be impossible to accomplish with human intervention in each transaction.

While preferred embodiments of the inventions have been described, it should be understood that the inventions are not so limited, and modifications may be made without departing from the inventions herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages of the inventions, and it is not necessarily expected that all of the described advantages will be achieved with every embodiment of the inventions. The scope of the inventions is defined by the appended claims, and all devices and methods that come within the meaning of the claims, either literally or by equivalence, are intended to be embraced therein.

1. A method of issuing a new credit card to a customer, comprising:
the customer providing customer information sufficient to uniquely identify the customer to a card issuer;
maintaining a chargeback database comprising a plurality of customer identifiers, each customer identifier being associated with a particular individual and being unique to the particular individual, the chargeback database further comprising historical chargeback data for each particular individual, the historical chargeback data for each particular individual being linked to the customer identifier associated with the particular individual;
the card issuer searching the chargeback database using the customer information to determine whether a customer identifier exists in the chargeback database associated with the customer information;
if a customer identifier exists in the chargeback database associated with the customer information, the card issuer retrieving the historical chargeback data for the customer; and
the card issuer issuing the new credit card to the customer or refusing to issue the new credit card to the customer based on the retrieved historical chargeback data.

2. The method of issuing a new credit card to a customer according to claim 1, wherein the customer identifiers are based on one or more government issued identifiers.

3. The method of issuing a new credit card to a customer according to claim 2, wherein the customer identifiers are encrypted values based on the one or more government issued identifiers.

4. The method of issuing a new credit card to a customer according to claim 2, wherein the customer identifiers are based on United States social security numbers.

5. The method of issuing a new credit card to a customer according to claim 2, wherein the customer identifiers are based on Indian AADHAAR and PAN numbers.

6. The method of issuing a new credit card to a customer according to claim 1, wherein the customer information comprises one or more government issued identifiers.

7. The method of issuing a new credit card to a customer according to claim 6, wherein the customer information comprises a United States social security number.

8. The method of issuing a new credit card to a customer according to claim 6, wherein the customer information comprises Indian AADHAAR and PAN numbers.

9. The method of issuing a new credit card to a customer according to claim 1, wherein a plurality of different card issuers searches the chargeback database using customer information for a plurality of different customers.

10. The method of issuing a new credit card to a customer according to claim 9, wherein at least some of the plurality of different card issuers are associated with different card networks.

11. The method of issuing a new credit card to a customer according to claim 1, wherein the historical chargeback data comprises merchant information identifying particular merchants associated with historical chargeback requests made by the customer.

12. The method of issuing a new credit card to a customer according to claim 1, wherein the historical chargeback data comprises a historical chargeback request made by the customer using a credit card issued by a different card issuer.

13. The method of issuing a new credit card to a customer according to claim 1, wherein the new credit card is associated with one card network, and the historical chargeback data comprises a historical chargeback request made by the customer using a credit card associated a different card network.

14. A method of denying a chargeback request by a customer according to claim 1, comprising:
the card issuer attributing a financial transaction to the customer;
the customer initiating a request to the card issuer for a chargeback of the financial transaction;
the card issuer searching the chargeback database using the customer information to retrieve the historical chargeback data for the customer; and
the card issuer denying the chargeback request for the financial transaction based on the retrieved historical chargeback data.

15. The method of denying a chargeback request by a customer according to claim 14, wherein if the search of the chargeback database by the card issuer retrieves no historical chargeback data for the customer, entering a new customer identifier associated with the customer information into the chargeback database and entering details of the request for the chargeback into the chargeback database as historical chargeback data linked to the new customer identifier.

16. The method of denying a chargeback request by a customer according to claim 14, wherein the customer identifiers are based on one or more government issued identifiers.

17. The method of denying a chargeback request by a customer according to claim 16, wherein the customer information comprises one or more government issued identifiers.

18. The method of denying a chargeback request by a customer according to claim 17, wherein a plurality of different card issuers searches the chargeback database using customer information for a plurality of different customers, and at least some of the plurality of different card issuers are associated with different card networks.

19. The method of issuing a new credit card to a customer according to claim 18, wherein the financial transaction is associated with one credit card associated with one card network, and the historical chargeback data comprises a historical chargeback request made by the customer using a different credit card associated a different card network.

20. The method of denying a chargeback request by a customer according to claim 19, wherein the customer identifiers are encrypted values based on the one or more government issued identifiers.
